(19) United States
(12) Patent Application Publication
(10) Pub. No.: US 2012/0171893 A1
(43) Pub. Date: Jul. 5, 2012

(54) ELECTRICAL CONNECTOR

(76) Inventors: Chun-Ming Li, Taipei (TW); Teng-Hsiang Lee, Taipei (TW); Jun-Long Wu, Taipei (TW); Ya-Hui Chang, Taipei (TW)

(21) Appl. No.: 12/980,331

(22) Filed: Dec. 29, 2010

(51) Int. Cl. H01R 13/60

(52) U.S. Cl. 439/529

(57) ABSTRACT

An electrical connector includes an insulating housing which has a base. Each side surface of the base protrudes outward to form a fixing block and a guiding block. A receiving groove is formed between the fixing block and the guiding block. A plurality of signal terminals are disposed in the insulating housing. A pair of positioning members each has a fixing board fastened in the fixing block. A front end of the fixing board extends frontward and then is arched oppositely to the base to form a flexible board elastically received in the receiving groove and has the apex project out of the receiving groove. When the electrical connector is inserted into the inserting mouth, the guiding block slips into the receiving fillister. The apex of the flexible board slips over the corresponding clipping element and then is restrained by the clipping element.

### BACKGROUND OF THE INVENTION

1. Field of the Invention

The present invention relates to an electrical connector, and particularly to an electrical connector capable of exactly connecting with a mating electronic apparatus.

2. The Related Art

Two electronic apparatus are connected with each other usually via an electrical connector. However, in the process of inserting the electrical connector into a matching electronic apparatus or an electrical matching element, the electrical connector often can not be exactly inserted into a matching room of the electronic apparatus or the electrical matching element, and the electrical connector is apt to shake at random in the matching room, as a result of poor manufacture, assembly or use. So the working life of the electrical connector is easily shortened.

### SUMMARY OF THE INVENTION

Accordingly, an object of the present invention is to provide an electrical connector electrically connecting with a portable hard disk. The portable hard disk has a storage body and two clipping elements. A rear end of the storage body defines an inserting mouth. Two opposite sides of the inserting mouth each defines a receiving fillister penetrating the rear end of the storage body. The clipping elements are respectively located behind the receiving fillisters of the inserting mouth. The electrical connector includes an insulating housing which has a base. A rear portion of each side surface of the base protrudes outward to form a fixing block. A front portion of each side surface of the base protrudes outward to form a guiding block spaced from the fixing block. A receiving groove is formed between the fixing block and the guiding block. A plurality of signal terminals are disposed in the insulating housing. A pair of positioning members each has a fixing board fastened in the fixing block. A front end of the fixing board extends frontward and then is arched oppositely to the base to form a flexible board elastically received in the receiving groove and has the apex project out of the receiving groove. When the electrical connector is inserted into the inserting mouth, the guiding block slips into the receiving fillister of the inserting mouth. The apex of the flexible board slips over the corresponding clipping element and then is restrained by the clipping element to avoid the electrical connector falling off the portable hard disk.

As described above, since the guiding block can exactly slip into the receiving fillister by the guidance of the guiding end, such structures can make the electrical connector exactly be received in the inserting mouth of the storage body and further prolong the working life of the electrical connector. Furthermore, the flexible boards are restrained by the clipping ends of the corresponding clipping elements to make the electrical connector firmly locked in the inserting mouth, so that ensure the stably electrical connection between the electrical connector and the portable hard disk.

### BRIEF DESCRIPTION OF THE DRAWINGS

The present invention will be apparent to those skilled in the art by reading the following description thereof, with reference to the attached drawings, in which:

FIG. 1 is a perspective view of an electrical connector in accordance with the present invention;

FIG. 2 is a perspective view of the electrical connector of FIG. 1 viewed from another angle;

FIG. 3 is a perspective view of a positioning member of the electrical connector of FIG. 1;

FIG. 4 is a perspective view of the electrical connector of FIG. 1 viewed from another angle;

FIG. 5 is a perspective view of the electrical connector and a portable hard disk;

FIG. 6 is an exploded, perspective view of the portable hard disk shown in FIG. 5;

FIG. 7 is a perspective view of the electrical connector connecting with the portable hard disk; and

FIG. 8 is a partial enlarged view of the enclosed portion labeled A shown in FIG. 7.

### DETAILED DESCRIPTION OF THE EMBODIMENT

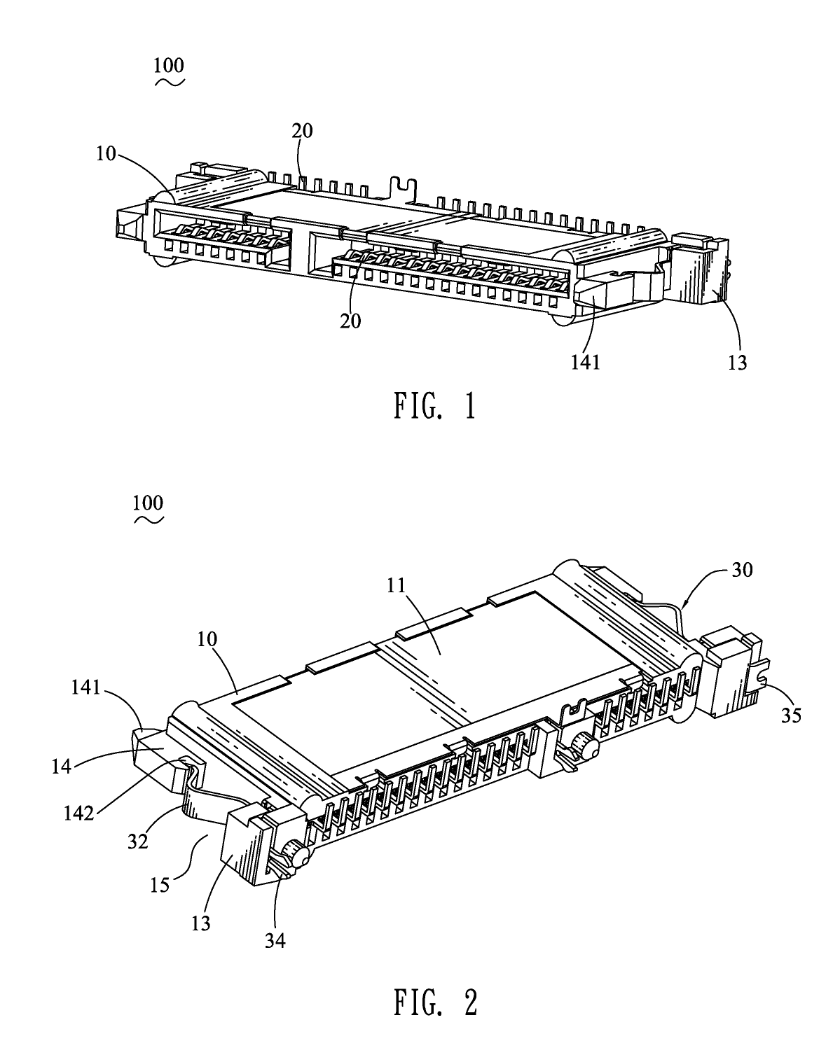

Referring to the drawings in greater detail, and first to FIG. 1, FIG. 2 and FIG. 4, the embodiment of the invention is embodied in an electrical connector 100. The electrical connector 100 includes an insulating housing 10, a plurality of signal terminals 20 and a pair of positioning members 30 disposed in the insulating housing 10 respectively.

Referring to FIGS. 1-2 and FIG. 4, the insulating housing 10 has a substantial rectangular base 11. A rear portion of each side surface of the base 11 protrudes outward to form a fixing block 13. A front portion of each side surface of the base 11 protrudes outward to form a guiding block 14 apart from the fixing block 13. A receiving groove 15 is formed between the fixing block 13 and the guiding block 14. A front end of the guiding block 14 extends frontward to form a substantially awl-shaped guiding end 141. A rear end of the guiding block 14 defines a constraining groove 142 communicating with the receiving groove 15. A top surface of the fixing block 13 defines a fixing groove 131 penetrating the fixing block 13 to communicate with the receiving groove 15. In this embodiment, the fixing groove 131 has a fastening slot 1311, a connecting slot 1312 and an inserting slot 1313 connected at two opposite ends of the fastening slot 1311. The fastening slot 1311 is opened in a substantial middle of the top surface of the fixing block 13 and extends perpendicularly to a front-to-rear direction of the fixing block 13. The connecting slot 1312 is opened in a front end of the fixing block 13 and extends along the front-to-rear direction of the fixing block 13 to connect the receiving groove 15 with one end of the fastening slot 1311 near to the base 10. A rear end of the fixing block 13 is recessed frontward to form the inserting slot 1313 connected with the other end of the fastening slot 1311 far away from the base 11 and opposite to the connecting slot 1312.

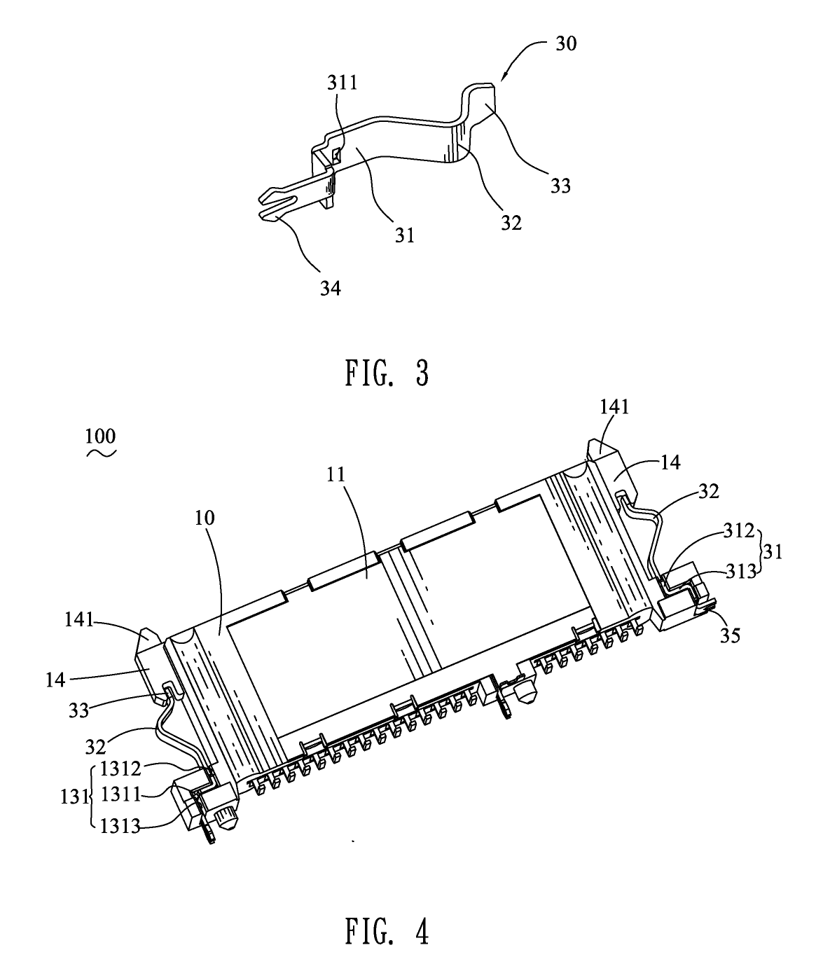

Referring to FIG. 3 and FIG. 4, one of the positioning members 30 has a substantially lying-L shaped fixing board 31 composed of a front plate 312 and a rear plate 313. A front end of the front plate 312 of the fixing board 31 extends frontward and then is arched sideward with a substantial lying-V shape to form a flexible board 32 having the apex located at the same side of the front plate 312 as a lateral end of the rear plate 313 of the fixing board 31. A distal end of the flexible board 32 extends frontward to form a restraining end 33. The lateral end of the rear plate 313 of the fixing board 31 extends rearward to form a substantially fork-shaped assembling portion 34. The front plate 312 of the fixing board 31 is punched sideward to form a buckling piece 311. The other positioning member 30 has a substantial same structure as the said positioning member 30. The difference between the two positioning members 30 is that the other positioning member 30 has a lying-L shaped soldering board 35 perpendicularly connected with the lateral end of the rear plate 313 and opposite to the flexible board 32.

Referring to FIGS. 1-4, in assembly, the signal terminal 20 is disposed in insulating housing 10. The fixing board 31 is fixed in the fixing block 13. The front plate 312 of the fixing board 31 is secured in the connecting slot 1312, with the buckling piece 311 abutting against a side of the connecting slot 1312. The rear plate 313 of the fixing board 31 is fastened in the fastening slot 1311. The assembling portion 34 and the soldering board 35 pass through the corresponding inserting slots 1313 to project out of the rear end of the fixing block 13. The flexible board 32 is elastically received in the receiving groove 15, with the apex of the flexible board 32 being opposite to the base 11 and projected out of the receiving groove 15. The restraining end 33 is movably restrained in the constraining groove 142 of the guiding block 14.

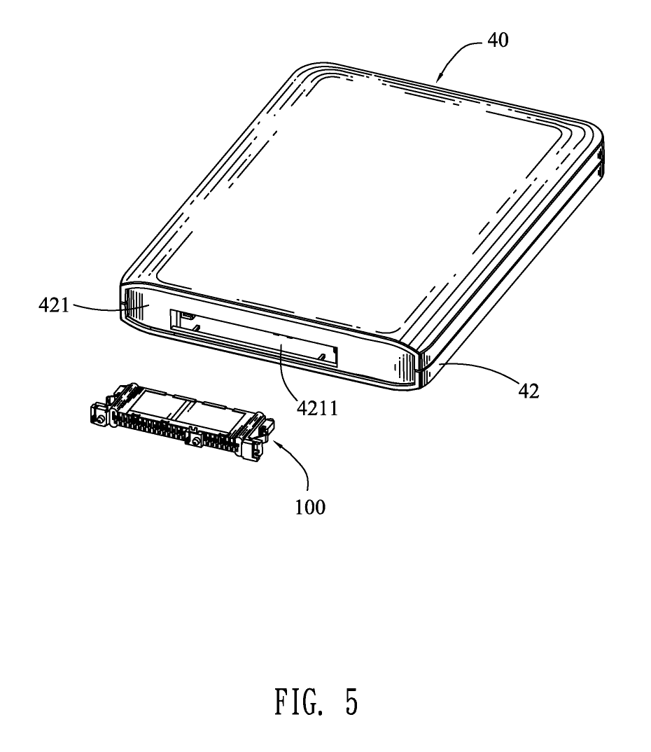

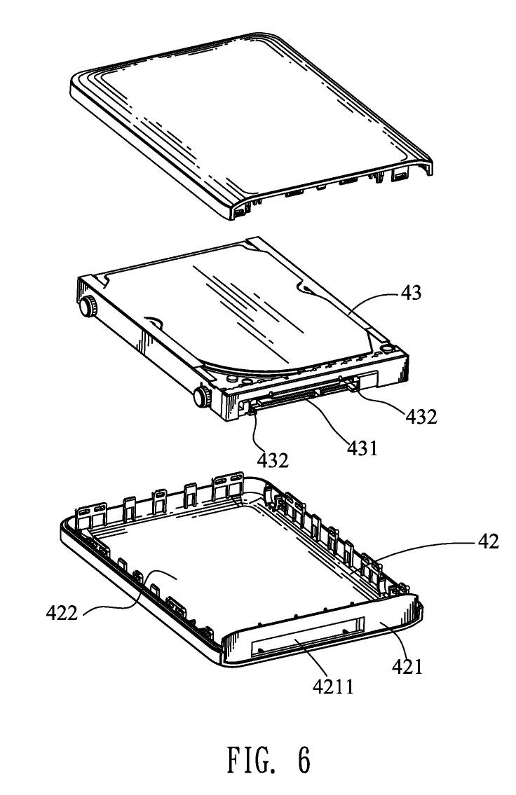

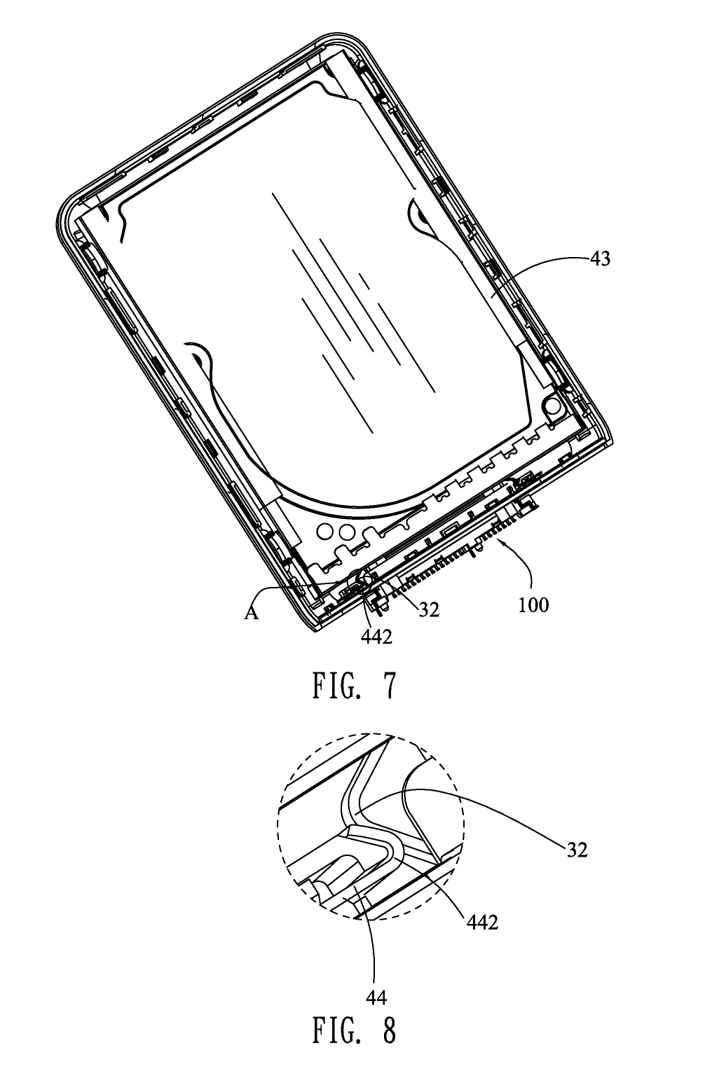

Referring to FIGS. 5-8, the electrical connector 100 is mated with a portable hard disk 40 which comprises a protecting shell 42, a storage body 43 and two clipping elements 44 disposed in the protecting shell 42 respectively. The protecting shell 42 has a rear plate 421 with a rectangular window 4211 opened therein, and a bottom plate 422. The storage body 43 defines an inserting mouth 431 opened at a rear end of thereof and facing the window 4211 of the protecting shell 42. Two opposite sides of the inserting mouth 431 each defines a receiving fillister 432 penetrating the rear end of the storage body 43. The clipping elements 44 are secured on the bottom plate 422 of the protecting shell 42 and between the rear end of the storage body 43 and the rear plate 421 of the protecting shell 42. The clipping elements 44 are spaced from each other and adjacent to two opposite ends of the window 4211. Each of the clipping elements 44 has a clipping end 442 projected behind the corresponding receiving fillister 432 of the inserting mouth 431.

Referring to FIGS. 5-7 again, when the electrical connector 100 electrically connects with the portable hard disk 40, the front of the electrical connector 100 passes through the window 4211 and is inserted in the inserting mouth 431 of the storage body 43. The guiding blocks 14 can exactly slip into the receiving fillisters 432 by means of the guidance of the guiding ends 141 to make the electrical connector 100 exactly received in the inserting mouth 431 of the storage body 43. In the process of inserting the electrical connector 100 into the portable hard disk 40, the clipping end 442 of the clipping element 44 presses the flexible board 32 of the positioning member 30 to make the flexible board 32 elastically received in the receiving groove 15 and the restraining end 33 move toward the base 11. The apexes of the flexible boards 32 slip over the clipping ends 442 of the corresponding clipping elements 44 and then are restrained by the clipping ends 442 to make the electrical connector 100 firmly locked in the inserting mouth 431 for assuring a stably electrical connection between the electrical connector 100 and the portable hard disk 40.

As described above, since the guiding block 14 can exactly slip into the receiving fillister 432 by the guidance of the guiding end 141, such structures can make the electrical connector 100 exactly be received in the inserting mouth 431 of the storage body 43 and further prolong the working life of the electrical connector 100. Furthermore, the flexible boards 32 are restrained by the clipping ends 442 of the corresponding clipping elements 44 to make the electrical connector 100 firmly locked in the inserting mouth 431, so that ensure the stably electrical connection between the electrical connector 100 and the portable hard disk 40.

The foregoing description of the present invention has been presented for the purposes of illustration and description. It is not intended to be exhaustive or to limit the invention to the precise form disclosed, and obviously many modifications and variations are possible in light of the above teaching. Such modifications and variations that may be apparent to those skilled in the art are intended to be included within the scope of this invention as defined by the accompanying claims.

What is claimed is:

1. An electrical connector electrically connecting with a portable hard disk, the portable hard disk having a storage body and two clipping elements, a rear end of the storage body defining an inserting mouth, two opposite sides of the inserting mouth each defining a receiving fillister penetrating the rear end of the storage body, the clipping elements being respectively located behind the receiving fillisters of the inserting mouth, the electrical connector comprising:
an insulating housing having a base, a rear portion of each side surface of the base protruding outward to form a fixing block, a front portion of each side surface of the base protruding outward to form a guiding block spaced from the fixing block, a receiving groove being formed between the fixing block and the guiding block;
a plurality of signal terminals disposed in the insulating housing; and
a pair of positioning members each having a fixing board fastened in the fixing block, a front end of the fixing board extending frontward and then being arched oppositely to the base to form a flexible board elastically received in the receiving groove and having the apex project out of the receiving groove,
wherein when the electrical connector is inserted into the inserting mouth, the guiding block slips into the receiving fillister of the inserting mouth, the apex of the flexible board slips over the corresponding clipping element and then is restrained by the clipping element to avoid the electrical connector falling off the portable hard disk.

2. The electrical connector as claimed in claim 1, wherein a front end of the guiding block extends frontward to form a substantial awl-shaped guiding end for guiding the guiding block to slip into the corresponding receiving fillister.

3. The electrical connector as claimed in claim 1, wherein a top surface of the fixing block defines a fastening slot opened in a substantial middle thereof and extending perpendicularly to a front-to-rear direction of the fixing block, and a connecting slot opened in a front end of the fixing block and extending along the front-to-rear direction of the fixing block to connect the receiving groove with one end of the fastening slot, the fixing board of the positioning member is of substantial lying-L shape and has a front plate fastened in the connecting slot and a rear plate fastened in the fastening slot, the flexible board is formed by extending from a front end of the front plate.

4. The electrical connector as claimed in claim 3, wherein a rear end of the fixing block is recessed frontward to form an inserting slot connected with the other end of the fastening slot, a lateral end of the rear plate of the fixing board extends rearward to form an assembling portion passing through the inserting slot to project out of the rear end of the fixing block.

5. The electrical connector as claimed in claim 4, wherein the connecting slot is nearer to the base of the insulating housing than the inserting slot.

6. The electrical connector as claimed in claim 3, wherein a rear end of the fixing block is recessed frontward to form an inserting slot connected with the other end of the fastening slot, a lateral end of the rear plate of the fixing board extends rearward and then is bent sideward to form a lying-L shaped soldering board fastened in the inserting slot and having a free end located behind the rear end of the fixing block.

7. The electrical connector as claimed in claim 4, wherein the connecting slot is nearer to the base of the insulating housing than the inserting slot.

8. The electrical connector as claimed in claim 3, wherein the front plate is punched sideward to form a buckling piece abutting against a side of the connecting slot.

9. The electrical connector as claimed in claim 1, wherein a rear end of the guiding block defines a constraining groove communicating with the receiving groove, a distal end of the flexible board extends frontward to form a restraining end movably constrained in the constraining groove.

10. The electrical connector as claimed in claim 1, wherein the flexible board is of substantial lying-V shape.
